(19) United States
(12) Patent Application Publication
(10) Pub. No.: US 2021/0370948 A1
(43) Pub. Date: Dec. 2, 2021

(54) VEHICLE CONTROL METHOD, VEHICLE CONTROL PROGRAM, AND VEHICLE CONTROL SYSTEM

(71) Applicant: Toyota Jidosha Kabushiki Kaisha, Toyota-shi Aichi-ken (JP)

(72) Inventors: Atsushi Yamaguchi, Nagakute-shi (JP); Yusuke Morita, Mishima-shi (JP)

(73) Assignee: Toyota Jidosha Kabushiki Kaisha, Toyota-shi Aichi-ken (JP)

(21) Appl. No.: 17/307,352

(22) Filed: May 4, 2021

(30) Foreign Application Priority Data
Jun. 2, 2020 (JP) 2020-096348

(51) Int. Cl. B60W 40/02; B60W 50/14; B60W 10/04; B60W 10/18; B60W 10/20

(52) U.S. Cl. CPC B60W 40/02; B60W 50/14; B60W 10/04; B60W 10/18; B60W 10/20; B60W 2420/40; G05D 1/0214; B60W 2552/00; B60W 2710/18; B60W 2710/20; B60W 2720/106; B60W 2720/125; B60W 2555/20

(57) ABSTRACT

A vehicle control method for controlling a vehicle includes: (A) detecting a rainfall condition or a non-rainfall condition using a first sensor mounted on the vehicle; (B) determining whether the vehicle is passing under an upper structure covering the vehicle using a second sensor mounted on the vehicle; (C) determining that the rainfall condition is continuing even when a transition from the rainfall condition to the non-rainfall condition is detected in a case where the vehicle passes under the upper structure; and (D) controlling the vehicle based on whether a weather condition is the rainfall condition or the non-rainfall condition.

### CROSS-REFERENCE TO RELATED APPLICATION

This application claims priority to Japanese Patent Application No. 2020-096348 filed on Jun. 2, 2020, incorporated herein by reference in its entirety.

### BACKGROUND

### 1. Technical Field

The present disclosure relates to a technique for controlling a vehicle. In particular, the present disclosure relates to a technique for controlling a vehicle based on weather conditions.

### 2. Description of Related Art

Japanese Unexamined Patent Application Publication No. 2019-093998 (JP 2019-093998 A) discloses a vehicle control device. The vehicle control device detects the state of an oncoming vehicle facing the own vehicle in the tunnel. Then, the vehicle control device determines whether the area ahead of the tunnel has bad weather based on the state of the oncoming vehicle.

### SUMMARY

Consider controlling the vehicle based on whether the weather condition is a rainfall condition. The rainfall condition means a bad weather condition where it is raining or snowing. The rainfall condition can be detected by using sensors mounted on the vehicle. However, the detection of the rainfall condition by the sensors is temporarily stopped while the vehicle is passing under an upper structure covering the vehicle. As a result, hunting of the vehicle control occurs each time the vehicle passes under the upper structure.

One object of the present disclosure is to provide a technique capable of suppressing hunting of the vehicle control based on whether the weather condition is a rainfall condition.

A first aspect relates to a vehicle control method for controlling a vehicle. The vehicle control method includes: detecting a rainfall condition or a non-rainfall condition using a first sensor mounted on the vehicle; determining whether the vehicle is passing under an upper structure covering the vehicle using a second sensor mounted on the vehicle; determining that the rainfall condition is continuing even when a transition from the rainfall condition to the non-rainfall condition is detected in a case where the vehicle passes under the upper structure; and controlling the vehicle based on whether a weather condition is the rainfall condition or the non-rainfall condition.

A second aspect relates to a vehicle control program for controlling a vehicle. The vehicle control program is executed by one or more processors. The one or more processors execute the vehicle control program to detect a rainfall condition or a non-rainfall condition based on a detection result by a first sensor mounted on the vehicle, to determine whether the vehicle is passing under an upper structure covering the vehicle based on a detection result by a second sensor mounted on the vehicle, determine that the rainfall condition is continuing even when a transition from the rainfall condition to the non-rainfall condition is detected in a case where the vehicle passes under the upper structure, and control the vehicle based on whether a weather condition is the rainfall condition or the non-rainfall condition.

A third aspect relates to a vehicle control system for controlling a vehicle. The vehicle control system includes: one or more processors; and one or more storage devices that store surrounding situation information indicating a situation around the vehicle which is detected by a sensor mounted on the vehicle. The one or more processors are configured to detect a rainfall condition or a non-rainfall condition based on the surrounding situation information, determine whether the vehicle is passing under an upper structure covering the vehicle based on the surrounding situation information, determine that the rainfall condition is continuing even when a transition from the rainfall condition to the non-rainfall condition is detected in a case where the vehicle passes under the upper structure, and control the vehicle based on whether a weather condition is the rainfall condition or the non-rainfall condition.

According to the present disclosure, vehicle control is performed based on whether the weather condition is the rainfall condition. In order to determine whether the weather condition is the rainfall condition, whether the vehicle is passing under the upper structure is also considered. Specifically, it is determined that the rainfall condition is continuing even when a transition from the rainfall condition to the non-rainfall condition is detected in a case where the vehicle passes under the upper structure; and Thus, hunting of the vehicle control when the vehicle passes under the upper structure is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an overview of a vehicle control system according to an embodiment of the present disclosure;

FIG. 2 is a block diagram showing a functional configuration of the vehicle control system according to the embodiment of the present disclosure;

FIG. 3 is a block diagram schematically showing a configuration example of the vehicle control system according to the embodiment of the present disclosure;

FIG. 4 is a block diagram showing an example of a sensor group and driving environment information according to the embodiment of the present disclosure;

FIG. 5 is a conceptual diagram illustrating an example of a tunnel passage determination process according to the embodiment of the present disclosure; and

FIG. 6 is a flowchart showing a weather condition determination process in summary according to the embodiment of the present disclosure.

### DETAILED DESCRIPTION OF EMBODIMENTS

An embodiment of the present disclosure will be described with reference to the accompanying drawings.

1. Overview

1-1. Vehicle Control System

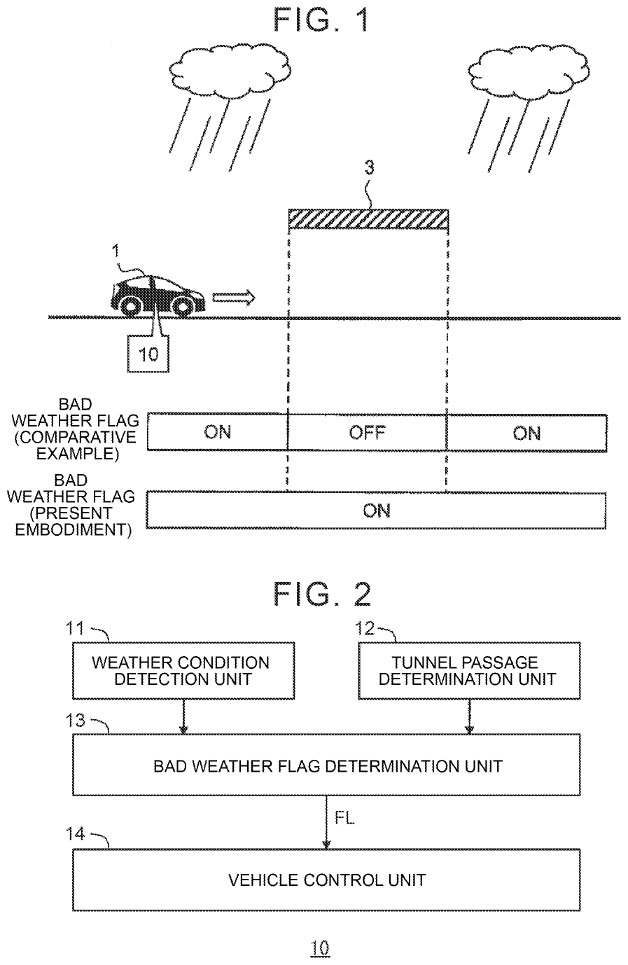

FIG. 1 is a conceptual diagram illustrating an overview of a vehicle control system 10 according to the present embodiment. The vehicle control system 10 controls a vehicle 1. Typically, the vehicle control system 10 is mounted on the vehicle 1. Alternatively, at least a part of the vehicle control system 10 may be disposed outside the vehicle 1 to remotely perform the vehicle control.

The vehicle control includes “vehicle device control” that automatically turns ON/OFF devices such as lights and wipers of the vehicle 1.

Further, the vehicle control includes “information provision control” that controls an output device mounted on the vehicle 1 to provide information to the driver. Examples of the output device include a display device and a speaker.

Further, the vehicle control includes “vehicle travel control” that automatically controls at least one of steering, acceleration, and deceleration of the vehicle 1. In particular, the vehicle travel control is applied to “driving support control” that supports the driving of the vehicle 1. Examples of the driving support control include autonomous driving control, risk avoidance control, lane tracing assist (LTA) control, and the like. The autonomous driving control controls autonomous driving of the vehicle 1. For example, the autonomous driving control performs the vehicle travel control so that the vehicle 1 autonomously travels toward the destination. The risk avoidance control performs at least one of the steering control and the braking control in order to reduce the risk of collision with an object in front of the vehicle 1. The lane tracing assist control performs the vehicle travel control so that the vehicle 1 travels along the traveling lane.

1-2. Vehicle Control Based on Weather Conditions

In the present embodiment, in particular, the vehicle control based on weather conditions will be considered. The vehicle control system 10 determines whether the weather condition is a rainfall condition or a non-rainfall condition using sensors mounted on the vehicle 1. Here, the rainfall condition means a bad weather condition where it is raining or snowing. On the other hand, the “non-rainfall condition” means a condition that is not the rainfall condition.

A bad weather flag FL indicates whether the weather condition is the rainfall condition or the non-rainfall condition. When it is determined that the weather condition is the rainfall condition, the vehicle control system 10 sets the bad weather flag FL to ON. When it is determined that the weather condition is the non-rainfall condition, the vehicle control system 10 sets the bad weather flag FL to OFF. Then, the vehicle control system 10 controls the vehicle based on the bad weather flag FL.

For example, when the bad weather flag FL is ON, the vehicle control system 10 performs the information provision control for notifying the driver of a warning. In particular, accuracy of the above-described driving support control may decrease in the rainfall condition. Thus, the vehicle control system 10 may perform the information provision control for notifying the driver of a warning when the bad weather flag FL is turned ON during the execution of the driving support control. When the driving support control being executed is the autonomous driving control, the vehicle control system 10 may notify the driver of a transition demand demanding the start of manual driving.

As another example, when the bad weather flag FL is ON, the vehicle control system 10 may automatically activate the wiper of the vehicle 1.

1-3. Vehicle Control Considering Upper Structure

Next, consider a case where the vehicle 1 passes under an upper structure 3 as shown in FIG. 1. The upper structure 3 is a structure that is present above the vehicle 1 and covers the vehicle 1. For example, the upper structure 3 is a structure constituting a tunnel. In this case, “the vehicle 1 passes under the upper structure 3” means that the vehicle 1 passes through the tunnel. In addition to tunnels, examples of the upper structure 3 include multilevel crossing of roads, roofs, shades, trees, and the like. In any case, the upper structure 3 suppresses rain or snow from falling. Under the upper structure 3, the vehicle 1 is covered by the upper structure 3, so that the detection of the rainfall condition by the sensors is temporarily stopped.

First, as a comparative example, consider a case where the detection result of the rainfall condition by the sensors is directly reflected in the bad weather flag FL. As shown in FIG. 1, before and after the upper structure 3, the sensor detects the rainfall condition, and the bad weather flag FL is set to ON. On the other hand, during the period in which the vehicle 1 passes under the upper structure 3, the detection of the rainfall condition by the sensors is temporarily stopped, and the bad weather flag FL is set to OFF. In this way, each time the vehicle 1 passes under the upper structure 3, the bad weather flag FL is switched between ON and OFF. As a result, hunting of the vehicle control based on the bad weather flag FL occurs. The driver of the vehicle 1 may feel inconvenient with such hunting of the vehicle control.

Therefore, the present embodiment provides a technique capable of suppressing hunting of the vehicle control when the vehicle 1 passes under the upper structure 3. Specifically, in the case where the vehicle 1 passes under the upper structure 3, the vehicle control system 10 determines (considers) that the rainfall condition is continuing even when the sensor detects the transition from the rainfall condition to the non-rainfall condition. In other words, when the condition transition from the rainfall condition to the non-rainfall condition arises from the passage of the vehicle 1 under the upper structure 3, the vehicle control system 10 discards the condition transition and determines that the rainfall condition is continuing. Accordingly, as shown in FIG. 1, the bad weather flag FL is kept ON even during the period when the vehicle 1 passes under the upper structure 3. As a result, hunting of the vehicle control based on the bad weather flag FL is suppressed.

FIG. 2 is a block diagram showing a functional configuration of the vehicle control system 10 according to the present embodiment. The vehicle control system 10 includes a weather condition detection unit 11, a tunnel passage determination unit 12, a bad weather flag determination unit 13, and a vehicle control unit 14 as functional blocks.

The weather condition detection unit 11 detects the weather condition (that is, the rainfall condition or the non-rainfall condition) using a first sensor mounted on the vehicle 1. The first sensor detects a situation around the vehicle 1. Based on the detection result by the first sensor, the weather condition detection unit 11 detects the rainfall condition or the non-rainfall condition. Specific examples of the process by the first sensor and the weather condition detection unit 11 will be described later.

The tunnel passage determination unit 12 determines whether the vehicle 1 is passing under the upper structure 3 using a second sensor mounted on the vehicle 1. The second sensor detects a situation around the vehicle 1. The second sensor may be the same as or different from the first sensor. The tunnel passage determination unit 12 determines whether the vehicle 1 is passing under the upper structure 3 based on the detection result of the second sensor. Specific examples of the process by the second sensor and the tunnel passage determination unit 12 will be described later.

The bad weather flag determination unit 13 determines whether the weather condition is the rainfall condition or the non-rainfall condition, and sets the bad weather flag FL. The bad weather flag determination unit 13 sets the bad weather flag FL in consideration of not only the detection result of the weather condition detection unit 11 but also the determination result by the tunnel passage determination unit 12.

Specifically, when the rainfall condition is detected by the weather condition detection unit 11, the bad weather flag determination unit 13 determines that the weather condition is the rainfall condition and sets the bad weather flag FL to ON. When the weather condition detection unit 11 detects the condition transition from the rainfall condition to the non-rainfall condition, the bad weather flag determination unit 13 determines whether the condition transition arises from the passage of the vehicle 1 under the upper structure 3. When the condition transition arises from the passage under the upper structure 3, the bad weather flag determination unit 13 discards the condition transition, determines that the rainfall condition is continuing, and maintains the bad weather flag FL ON. On the other hand, when the condition transition does not arise from the passage under the upper structure 3 (that is, when the rain stops), the bad weather flag determination unit 13 determines that the weather condition is the non-rainfall condition, and sets the bad weather flag FL to OFF.

The vehicle control unit 14 performs the vehicle control for controlling the vehicle 1. In particular, the vehicle control unit 14 performs the vehicle control based on the bad weather flag FL set by the bad weather flag determination unit 13. That is, the vehicle control unit 14 performs the vehicle control based on whether the weather condition is the rainfall condition or the non-rainfall condition.

1-4. Effects

As described above, the vehicle control system 10 according to the present embodiment controls the vehicle 1 based on whether the weather condition is the rainfall condition. In order to determine whether the weather condition is the rainfall condition, the vehicle control system 10 also takes into account whether the vehicle 1 is passing under the upper structure 3. Specifically, in the case where the vehicle 1 passes under the upper structure 3, the vehicle control system 10 determines that the rainfall condition in continuing even when the transition from the rainfall condition to the non-rainfall condition is detected. As a result, hunting of the vehicle control when the vehicle 1 passes under the upper structure 3 is suppressed. Hunting of the vehicle control is suppressed, so that the inconvenience felt by the driver of the vehicle 1 is reduced.

For example, when the weather condition is the rainfall condition, the vehicle control system 10 performs the information provision control that notifies the driver of a warning. In particular, the vehicle control system 10 may perform the information provision control that notifies the driver of a warning when the weather condition becomes the rainfall condition during execution of the driving support control. According to the present embodiment, it is possible to suppress the warning from being unnecessarily turned ON/OFF each time the vehicle 1 passes under the upper structure 3. As a result, the inconvenience felt by the driver of the vehicle 1 is reduced.

Further, when the weather condition before the vehicle 1 passes under the upper structure 3 is the rainfall condition, the warning to the driver continues even during the period in which the vehicle 1 passes under the upper structure 3. It is highly possible that the weather condition after the vehicle 1 passes under the upper structure 3 is also the rainfall condition. Therefore, the warning to the driver continues. That is, it is possible to notify the driver in advance of the rainfall condition after the vehicle 1 passes under the upper structure 3, which further ensures safety.

Hereinafter, the vehicle control system 10 according to the present embodiment will be described in more detail.

2. Specific Example of Vehicle Control System

2-1. Configuration Example

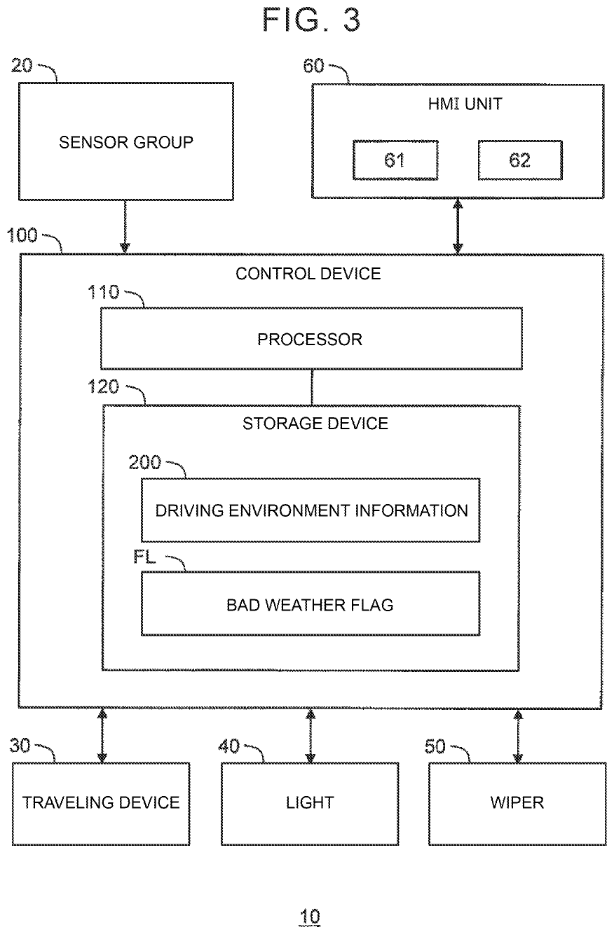

FIG. 3 is a block diagram schematically showing a configuration example of the vehicle control system 10 according to the present embodiment. The vehicle control system 10 includes a sensor group 20, a traveling device 30, a light 40, a wiper 50, a human machine interface (HMI) unit 60, and a control device 100.

The sensor group 20 detects the situation around the vehicle 1 and the state of the vehicle 1. Specific examples of the sensor group 20 will be described later.

The traveling device 30 includes a steering device, a driving device, and a braking device. The steering device steers the wheels of the vehicle 1. For example, the steering device includes a power steering (electric power steering (EPS)) device. The driving device is a driving power source that generates a driving force. Examples of the driving device include an engine, an electric motor, an in-wheel motor, and the like. The braking device generates a braking force.

The light 40 includes a headlight and a fog lamp. The wiper 50 is installed in a windshield, a rear window, and the like.

The HMI unit 60 is an interface for providing information to the driver of the vehicle 1 and receiving information from the driver. Specifically, the HMI unit 60 has an input device 61 and an output device 62. Examples of the input device 61 include a touch panel, a switch, a microphone, and the like. Examples of the output device 62 include a display device, a speaker, and the like. Examples of the display device include a display installed in an instrument panel, a head-up display (HUD), and the like.

The control device 100 controls the vehicle 1. Typically, the control device 100 is a microcomputer mounted on the vehicle 1. The control device 100 is also referred to an electronic control unit (ECU). The control device 100 may be composed of a plurality of ECUs. Alternatively, the control device 100 may be an information processing device outside the vehicle 1. In that case, the control device 100 communicates with the vehicle 1 and controls the vehicle 1 remotely.

The control device 100 includes one or more processors 110 and one or more storage devices 120. Hereinafter, for the sake of simplicity, the one or more processors 110 will be simply referred to as “processor 110”, and the one or more storage devices 120 will be simply referred to as “storage device 120”. The processor 110 executes various processes. Various types of information are stored in the storage device 120. Examples of the storage device 120 include a volatile memory, a non-volatile memory, and the like. When the processor 110 executes a “vehicle control program” that is a computer program, various processes executed by the processor 110 (control device 100) are realized. The vehicle control program is stored in the storage device 120 or recorded on a computer-readable storage medium.

2-2. Information Acquisition Process

The processor 110 executes an “information acquisition process” for acquiring driving environment information 200 indicating the driving environment of the vehicle 1. The driving environment information 200 is acquired based on the detection results of the sensor group 20 mounted on the vehicle 1. The acquired driving environment information 200 is stored in the storage device 120.

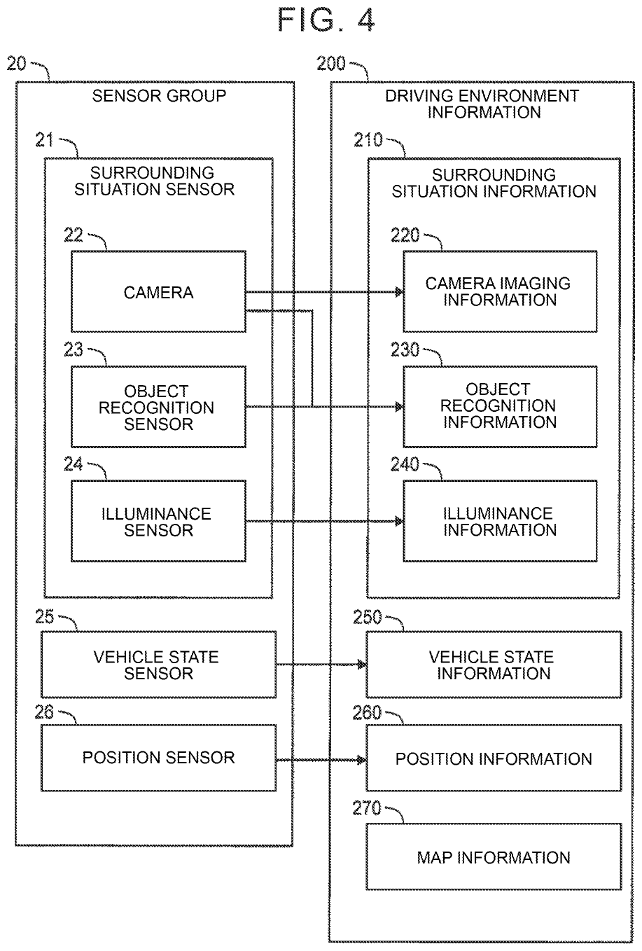

FIG. 4 is a block diagram showing an example of the sensor group 20 and the driving environment information 200. The sensor group 20 includes a surrounding situation sensor 21, a vehicle state sensor 25, and a position sensor 26. The driving environment information 200 includes surrounding situation information 210, vehicle state information 250, position information 260, and map information 270.

The surrounding situation sensor 21 detects a situation around the vehicle 1. For example, the surrounding situation sensor 21 includes a camera 22, an object recognition sensor 23, an illuminance sensor 24, and the like. The camera 22 captures the situation around the vehicle 1. The object recognition sensor 23 is a sensor that recognizes objects around the vehicle 1, and includes at least one of a laser imaging detection and ranging (LiDAR) and a millimeter-wave radar. The illuminance sensor 24 measures the illuminance around the vehicle 1. The surrounding situation sensor 21 may include a rain sensor that is a dedicated sensor for detecting a rainfall condition.

The surrounding situation information 210 is information indicating the situation around the vehicle 1. The processor 110 acquires the surrounding situation information 210 based on the detection result by the surrounding situation sensor 21. The surrounding situation information 210 includes camera imaging information 220, object recognition information 230, and illuminance information 240.

The camera imaging information 220 indicates an imaging result by the camera 22. For example, the camera imaging information 220 includes images indicating the situation around the vehicle 1 captured by the camera 22.

The object recognition information 230 is information indicating a recognition result of the objects around the vehicle 1. Examples of the objects around the vehicle 1 include the upper structure 3, other vehicles, pedestrians, signs, white lines, and the like. The object are recognized by analyzing the image captured by the camera 22. Further, the objects are recognized by the object recognition sensor 23. The object recognition information 230 indicates at least relative positions of the recognized objects with respect to the vehicle 1.

The illuminance information 240 indicates the illuminance measured by the illuminance sensor 24.

The vehicle state sensor 25 detects the state of the vehicle 1. Examples of the vehicle state sensor 25 include a vehicle speed sensor, a yaw rate sensor, a lateral acceleration sensor, a steering angle sensor, and the like.

The vehicle state information 250 is information indicating the state of the vehicle 1. Examples of the state of the vehicle 1 include a vehicle speed, a yaw rate, a lateral acceleration, a steering angle, and the like. The processor 110 acquires the vehicle state information 250 from the detection result by the vehicle state sensor 25.

The position sensor 26 detects the position and orientation of the vehicle 1. Examples of the position sensor 26 include a Global Positioning System (GPS) sensor.

The position information 260 is information indicating the position and orientation of the vehicle 1. The processor 110 acquires the position information 260 from the detection result by the position sensor 26. Further, the processor 110 may acquire more accurate position information 260 by well-known localization based on the surrounding situation information 210.

The map information 270 indicates a lane arrangement, a road shape, and the like. The map information 270 may include the position of the upper structure 3. The processor 110 acquires the map information 270 of the required area from the map database. The map database may be stored in a predetermined storage device mounted on the vehicle 1, or may be stored in a management server outside the vehicle 1. In the latter case, the processor 110 communicates with a management server and acquires the necessary map information 270.

2-3. Weather Condition Determination Process

The processor 110 executes a “weather condition determination process” for determining whether the weather condition is the rainfall condition or the non-rainfall condition. The bad weather flag FL indicates the result of the weather condition determination process, that is, whether the weather condition is the rainfall condition or the non-rainfall condition. Specifically, the bad weather flag FL=ON indicates the rainfall condition, and the bad weather flag FL=OFF indicates the non-rainfall condition. The bad weather flag FL is stored in the storage device 120. Details of the weather condition determination process will be described later in Section 3.

2-4. Vehicle Control

The processor 110 executes the vehicle control for controlling the vehicle 1. The vehicle control unit 14 shown in FIG. 2 is realized by the processor 110. As described below, the processor 110 executes various types of vehicle control. Some kinds of vehicle control are performed based on the bad weather flag FL stored in the storage device 120.

2-4-1. Vehicle Travel Control

The processor 110 executes the vehicle travel control that controls traveling of the vehicle 1. The vehicle travel control includes at least one of steering control, acceleration control, and deceleration control. The processor 110 executes the vehicle travel control by controlling the traveling device 30. Specifically, the processor 110 executes the steering control by controlling the steering device. Further, the processor 110 executes the acceleration control by controlling the driving device. Further, the control device 100 executes the deceleration control by controlling the braking device.

2-4-2. Driving Support Control

The vehicle travel control is applied to the driving support control that supports the driving of the vehicle 1. That is, the processor 110 supports the driving of the vehicle 1 by automatically controlling at least one of steering, acceleration, and deceleration of the vehicle 1. Examples of the driving support control include the autonomous driving control, the risk avoidance control, the lane tracing assist control, and the like. The driving support control is executed based on the driving environment information 200.

An example of the autonomous driving control is as follows. The processor 110 generates a travel plan for reaching the destination based on the position information 260 and the map information 270. Further, the processor 110 generates a target trajectory according to the travel plan. The target trajectory includes a target position and a target speed of the vehicle 1 on the road on which the vehicle 1 travels. Then, the processor 110 performs the vehicle travel control so that the vehicle 1 follows the target trajectory.

An example of the risk avoidance control is as follows. The processor 110 recognizes an object that is present in front of the vehicle 1 and that may collide with the vehicle 1, based on the vehicle state information 250 (vehicle speed, and the like) and the object recognition information 230. The processor 110 generates the target trajectory to reduce the risk of collision with the recognized object. For example, the target trajectory requires steering in a direction away from the object. Alternatively, the target trajectory requires deceleration. Then, the processor 110 performs the vehicle travel control (at least one of the steering control and the braking control) so that the vehicle 1 follows the target trajectory.

An example of the lane tracing assist control is as follows. For example, the target trajectory is a line passing through the center of the traveling lane. The processor 110 can calculate the target trajectory passing through the center of the traveling lane based on the map information 270 and the position information 260. Alternatively, the processor 110 can recognize the traveling lane and calculate the target trajectory based on the object recognition information 230 (white line information). The processor 110 performs the vehicle travel control so that the vehicle 1 follows the target trajectory.

2-4-3. Vehicle Device Control

The processor 110 automatically turns ON/OFF the light 40 based on the illuminance indicated by the illuminance information 240. For example, when the illuminance is lower than a threshold value, the processor 110 automatically turns ON the light 40. On the other hand, when the illuminance is equal to or higher than the threshold value, the processor 110 automatically turns OFF the light 40.

Further, the processor 110 may automatically turn ON/OFF the wiper 50 based on the bad weather flag FL. For example, when the bad weather flag FL=ON, the processor 110 automatically turns ON the wiper 50. On the other hand, when the bad weather flag FL=OFF, the processor 110 automatically turns OFF the wiper 50.

2-4-4. Information Provision Control

The processor 110 performs the information provision control that controls the output device 62 to provide information to the driver. For example, when the bad weather flag FL=ON, the processor 110 controls the output device 62 to notify the driver of a warning. In particular, accuracy of the above-described driving support control may decrease in the rainfall condition. Thus, the processor 110 may control the output device 62 to notify the driver of the warning when the bad weather flag FL is turned ON during the execution of the driving support control. When the driving support control being executed is the autonomous driving control, the processor 110 may notify the driver of a transition demand demanding the start of manual driving.

3. Weather Condition Determination Process

As described above, the processor 110 executes the weather condition determination process and sets the bad weather flag FL. As described below, the weather condition determination process includes a weather condition detection process, a tunnel passage determination process, and a bad weather flag determination process. The weather condition detection process, the tunnel passage determination process, and the bad weather flag determination process correspond to the processes executed by the weather condition detection unit 11, the tunnel passage determination unit 12, and the bad weather flag determination unit 13, respectively, shown in FIG. 2. That is, the weather condition detection unit 11, the tunnel passage determination unit 12, and the bad weather flag determination unit 13 shown in FIG. 2 are realized by the processor 110.

3-1. Weather Condition Detection Process

The processor 110 executes the “weather condition detection process” that detects the weather condition (that is, the rainfall condition or the non-rainfall condition). For the weather condition detection process, the surrounding situation sensor 21 (first sensor) that detects the condition around the vehicle 1 is used. That is, the processor 110 detects the rainfall condition or the non-rainfall condition based on the surrounding situation information 210.

For example, the first sensor is the object recognition sensor 23. The object recognition sensor 23 includes at least one of a LiDAR and a millimeter wave radar. A laser beam output from the LiDAR or a radio wave output from the millimeter wave radar is reflected by raindrops or snow in the air. The amount of raindrops or snow is calculated based on the reflection condition. When the amount of raindrops or snow is equal to or more than or the threshold value, the weather condition is determined to be the rainfall condition. That is, the processor 110 can detect the rainfall condition or the non-rainfall condition based on the object recognition information 230 indicating the recognition result by the object recognition sensor 23.

As another example, the first sensor may be the camera 22. For example, the camera 22 is installed inside the vehicle 1 and captures the situation in front of the vehicle 1. By analyzing the image captured by the camera 22, raindrops and snow adhering to the windshield or raindrops and snow in a space can be detected. When the amount of raindrops or snow is equal to or more than or the threshold value, the weather condition is determined to be the rainfall condition. That is, the processor 110 can detect the rainfall condition or the non-rainfall condition based on the camera imaging information 220 indicating the imaging result by the camera 22.

As yet another example, the first sensor may be the rain sensor that is a dedicated sensor for detecting the rainfall condition. In this case, the processor 110 detects the rainfall condition or the non-rainfall condition with the rain sensor.

3-2. Tunnel Passage Determination Process

The processor 110 executes a “tunnel passage determination process” for determining whether the vehicle 1 is passing under the upper structure 3. Here, the wording “tunnel passage” is not limited to passage through the tunnel, but means passage under the upper structure 3. For the tunnel passage determination process, the surrounding situation sensor 21 (second sensor) that detects the situation around the vehicle 1 is used. That is, the processor 110 determines whether the vehicle 1 is passing under the upper structure 3 based on the surrounding situation information 210.

For example, the second sensor is the illuminance sensor 24. The processor 110 determines whether the vehicle 1 is passing under the upper structure 3 based on the illuminance indicated by the illuminance information 240. In this case, the illuminance sensor 24 and the illuminance information 240 used for automatically turning ON/OFF the light 40 are also used for the tunnel passage determination process.

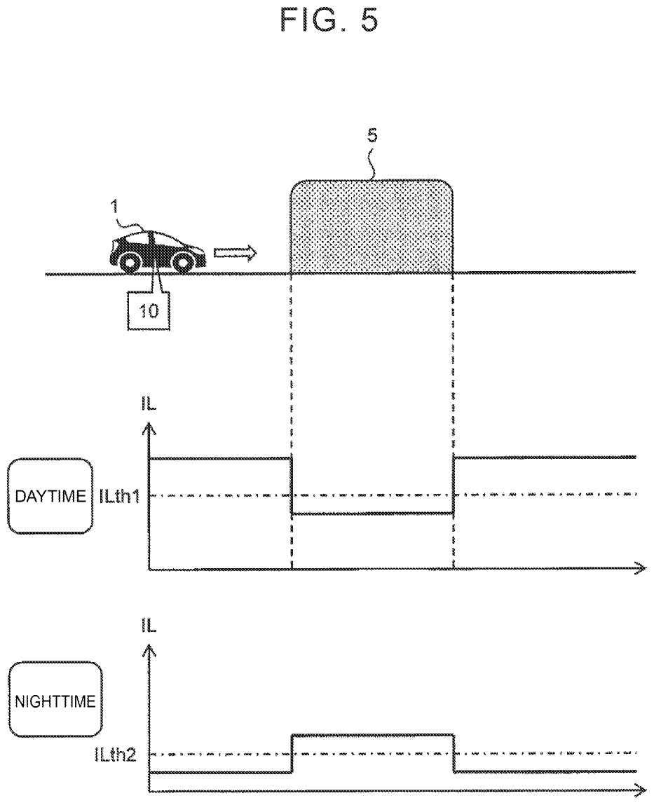

FIG. 5 is a conceptual diagram illustrating an example of the tunnel passage determination process using the illuminance sensor 24. In the example shown in FIG. 5, the upper structure 3 is a structure constituting a tunnel 5. In this case, the wording “the vehicle 1 passes under the upper structure 3” means that the vehicle 1 passes through the tunnel 5.

In the daytime, an illuminance IL outside the tunnel 5 is equal to or higher than a first threshold ILth1. On the other hand, the illuminance IL inside the tunnel 5 is lower than the first threshold ILth1. In the daytime, when the illuminance IL is equal to or higher than the first threshold value ILth1, the processor 110 determines that the vehicle 1 is outside the tunnel 5. When the illuminance IL decreases to a value lower than the first threshold value ILth1, the processor 110 determines that the vehicle 1 has entered the tunnel 5. When the illuminance IL returns to the value equal to or higher than the first threshold value ILth1, the processor 110 determines that the vehicle 1 has come out of the tunnel 5.

In the nighttime, the illuminance IL outside the tunnel 5 is equal to or lower than a second threshold value ILth2. On the other hand, the illuminance IL inside the tunnel 5 is higher than the second threshold ILth2. In the nighttime, when the illuminance IL is equal to or lower than the second threshold value ILth2, the processor 110 determines that the vehicle 1 is outside the tunnel 5. When the illuminance IL increases to a value higher than the second threshold value ILth2, the processor 110 determines that the vehicle 1 has entered the tunnel 5. When the illuminance IL returns to the value equal to or lower than the second threshold value ILth2, the processor 110 determines that the vehicle 1 has come out of the tunnel 5.

As another example, the second sensor may be the camera 22. The camera imaging information 220 includes an amount of exposure. By using the amount of exposure instead of the above-mentioned illuminance IL, it can be determined whether the vehicle 1 is passing through the tunnel 5.

As yet another example, the second sensor may be the camera 22 or the object recognition sensor 23. The processor 110 can recognize the upper structure 3 by analyzing the image captured by the camera 22. Alternatively, the upper structure 3 can also be recognized by the object recognition sensor 23 such as a LiDAR or a millimeter wave radar. The object recognition information 230 indicates the relative position of the recognized upper structure 3 with respect to the vehicle 1. That is, the processor 110 determines whether the vehicle 1 is passing under the upper structure 3 based on the object recognition information 230.

As yet another example, the second sensor may be the position sensor 26. When the map information 270 indicates the position of the upper structure 3, the processor 110 can determine whether the vehicle 1 is passing under the upper structure 3 based on the position information 260 and the map information 270.

3-3. Bad Weather Flag Determination Process

The processor 110 executes a “bad weather flag determination process” that determines whether the weather condition is the rainfall condition or the non-rainfall condition and sets the bad weather flag FL. The bad weather flag determination process is executed by considering not only the result of the weather condition detection process but also the result of the tunnel passage determination process.

Specifically, when the rainfall condition is detected through the weather condition detection process, the processor 110 determines that the weather condition is the rainfall condition and sets the bad weather flag FL to ON.

When the condition transition from the rainfall condition to the non-rainfall condition is detected through the weather condition detection process, the processor 110 determines whether the condition transition arises from the passage of the vehicle 1 under the upper structure 3. For example, the processor 110 compares a condition transition detection timing with a tunnel entry timing. The condition transition detection timing is a timing at which the condition transition from the rainfall condition to the non-rainfall condition is detected through the weather condition detection process. On the other hand, the tunnel entry timing is a timing at which entry of the vehicle 1 into a space under the upper structure 3 is detected through the tunnel passage determination process. When a difference between the condition transition detection timing and the tunnel entry timing is within a predetermined time, the processor 110 determines that the condition transition arises from (related to) the passage under the upper structure 3.

When the condition transition arises from the passage under the upper structure 3, the processor 110 discards the condition transition, determines that the rainfall condition is continuing, and maintains the bad weather flag FL ON. On the other hand, when the condition transition does not arise from the passage under the upper structure 3 (that is, when the rain stops), the processor 110 determines that the weather condition is the non-rainfall condition, and sets the bad weather flag FL to OFF.

3-4. Process Flow

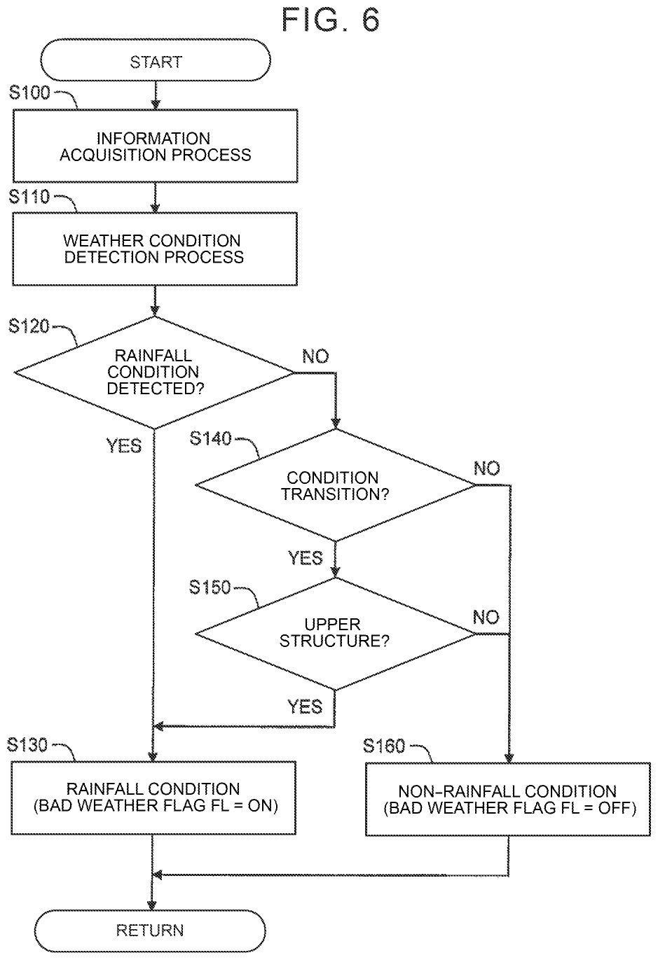

FIG. 6 is a flowchart schematically showing the weather condition determination process in summary according to the present embodiment. The process flow shown in FIG. 6 is repeatedly executed at regular cycles.

In step S100, the processor 110 executes the above-described information acquisition process to acquire the driving environment information 200. The driving environment information 200 is stored in the storage device 120.

In the subsequent step S110, the processor 110 executes the above-described weather condition detection process.

In step S120, the processor 110 determines whether the rainfall condition is detected through the weather condition detection process. When the rainfall condition is detected (step S120; Yes), the process proceeds to step S130. On the other hand, when the rainfall condition is not detected, that is, when the non-rainfall condition is detected (step S120; No), the process proceeds to step S140.

In step S130, the processor 110 determines that the weather condition is the rainfall condition, and sets the bad weather flag FL to ON.

In step S140, the processor 110 determines whether the detection of the non-rainfall condition in step S120 is based on the condition transition from the rainfall condition to the non-rainfall condition. When the condition transition from the rainfall condition to the non-rainfall condition has occurred (step S140; Yes), the process proceeds to step S150. In other cases (step S140; No), the process proceeds to step S160.

In step S150, the processor 110 determines whether the condition transition arises from the passage of the vehicle 1 under the upper structure 3. When the condition transition arises from the passage under the upper structure 3 (step S150; Yes), the processor 110 discards the condition transition. Then, the process proceeds to step S130 described above. On the other hand, when the condition transition does not arise from the passage under the upper structure 3 (step S150; No), the process proceeds to step S160.

In step S160, the processor 110 determines that the weather condition is the non-rainfall condition, and sets the bad weather flag FL to OFF.

Through the processes described above, it is possible to suppress the occurrence of hunting of the bad weather flag FL when the vehicle 1 passes under the upper structure 3. As a result, hunting of the vehicle control based on the bad weather flag FL is suppressed from occurring.

What is claimed is:

1. A vehicle control method for controlling a vehicle, the vehicle control method comprising:
detecting a rainfall condition or a non-rainfall condition using a first sensor mounted on the vehicle;
determining whether the vehicle is passing under an upper structure covering the vehicle using a second sensor mounted on the vehicle;
determining that the rainfall condition is continuing even when a transition from the rainfall condition to the non-rainfall condition is detected in a case where the vehicle passes under the upper structure; and
controlling the vehicle based on whether a weather condition is the rainfall condition or the non-rainfall condition.

2. The vehicle control method according to claim 1, further comprising:
determining that the weather condition is the rainfall condition when the rainfall condition is detected;
determining whether the transition arises from passage of the vehicle under the upper structure when the transition from the rainfall condition to the non-rainfall condition is detected;
discarding the transition and determining that the rainfall condition is continuing when the transition arises from the passage of the vehicle under the upper structure; and
determining that the weather condition is the non-rainfall condition when the transition does not arise from the passage of the vehicle under the upper structure.

3. The vehicle control method according to claim 1, wherein controlling the vehicle includes controlling an output device mounted on the vehicle to notify a driver of a warning when the weather condition is the rainfall condition.

4. The vehicle control method according to claim 1, further comprising executing driving support control that automatically controls at least one of steering, acceleration, and deceleration of the vehicle, wherein controlling the vehicle includes controlling an output device mounted on the vehicle to notify a driver of a warning when the weather condition is the rainfall condition during execution of the driving support control.

5. The vehicle control method according to claim 1, wherein:
the second sensor is an illuminance sensor that measures an illuminance around the vehicle; and
whether the vehicle is passing under the upper structure is determined based on the illuminance.

6. A vehicle control program for controlling a vehicle, wherein:
the vehicle control program is executed by one or more processors; and
the one or more processors execute the vehicle control program
to detect a rainfall condition or a non-rainfall condition based on a detection result by a first sensor mounted on the vehicle,
to determine whether the vehicle is passing under an upper structure covering the vehicle based on a detection result by a second sensor mounted on the vehicle,
to determine that the rainfall condition is continuing even when a transition from the rainfall condition to the non-rainfall condition is detected in a case where the vehicle passes under the upper structure, and
to control the vehicle based on whether a weather condition is the rainfall condition or the non-rainfall condition.

7. A vehicle control system for controlling a vehicle, the vehicle control system comprising:
one or more processors; and
one or more storage devices that store surrounding situation information indicating a situation around the vehicle which is detected by a sensor mounted on the vehicle, wherein the one or more processors are configured to
detect a rainfall condition or a non-rainfall condition based on the surrounding situation information,
determine whether the vehicle is passing under an upper structure covering the vehicle based on the surrounding situation information,
determine that the rainfall condition is continuing even when a transition from the rainfall condition to the non-rainfall condition is detected in a case where the vehicle passes under the upper structure, and
control the vehicle based on whether a weather condition is the rainfall condition or the non-rainfall condition.
